(19) United States
(12) Patent Application Publication
(10) Pub. No.: US 2016/0138334 A1
(43) Pub. Date: May 19, 2016

(54) CRANK FOR EXTENDING AND RETRACTING A SHADE

(71) Applicant: Gale Pacific USA Inc., Altamonte Springs, FL (US)

(72) Inventor: David Rhys Dean, Oviedo, FL (US)

(21) Appl. No.: 14/543,410

(22) Filed: Nov. 17, 2014

(51) Int. Cl. E06B 9/76; E06B 9/78; E06B 9/42; F16H 1/16; F16D 3/44

(52) U.S. Cl. CPC E06B 9/76; F16H 1/16; F16D 3/44; E06B 9/42; E06B 9/78

(57) ABSTRACT

A crank for extending and retracting a shade, blind or the like of the type mounted on a horizontally-positioned roller, including a crank housing, a crank stud mounted for rotation in the crank housing and having an end segment adapted to extend horizontally from the housing to be positioned in driving relation to a horizontal crank socket in an end of the roller, and a crankshaft positioned for rotation in the crank housing at a right angle to the crank stud. A right-angle gear assembly is positioned in the crank housing and interconnects the crank stud and crankshaft for transmitting rotation of the crankshaft to the crank stud. A universal joint is positioned on an end of the crankshaft for permitting the crankshaft to be rotated by non-axially aligned rotation of the crankshaft.

### TECHNICAL FIELD AND BACKGROUND OF THE INVENTION

This invention relates to a crank for use in extending and retracting shades. As used in this application, the term “shade” is used broadly to refer to shades, blinds, curtains and other window and door coverings and awnings that are wrapped around a horizontally-mounted, elongate rod, or “roller”, and raised and lowered by rotating the roller selectively in a direction to extend or retract the covering. The shades may be “filter”, “blackout” or other types, and may be manually or motor-operated.

Prior art cranks typically require that the driving force rotating the crank be co-axial with the crankshaft. This requires the operator to stand in a position very close to the door or window and rotate a pole in a vertical position. This may be difficult in situations when furniture, plants or other obstacles are present near the window or door. In any event, it is more ergonomic to be able to stand where the hands and arms can be extended into a natural position when operating the crank. Similarly, it may not be suitable in all instances to mount a motor directly beneath the crank.

### SUMMARY OF THE INVENTION

Therefore, it is an object of the invention to provide a crank for extending and retracting shades.

It is another object to provide a crank for extending and retracting shades that permits the driving force operating the crank to be in a non-coaxial relationship with the crankshaft.

These and other objects and advantages of the invention are achieved by providing a crank for extending and retracting a shade, blind or the like of the type mounted on a horizontally-positioned roller, including a crank housing, a crank stud mounted for rotation in the crank housing and having an end segment adapted to extend horizontally from the housing to be positioned in driving relation to a horizontal crank socket in an end of the roller, and a crankshaft positioned for rotation in the crank housing at a right angle to the crank stud. A right-angle gear assembly is positioned in the crank housing and interconnects the crank stud and crankshaft for transmitting rotation of the crankshaft to the crank stud. A universal joint is positioned on an end of the crankshaft for permitting the crankshaft to be rotated by non-axially aligned rotation of the crankshaft.

According to another embodiment of the invention, the right-angle gear assembly includes a driven gear coaxially-mounted on the crank stud and a driving gear coaxially-mounted on the crankshaft.

According to another embodiment of the invention, the right-angle gear assembly includes a driven helical gear coaxially-mounted on the crank stud and a driving worm gear coaxially-mounted on the crankshaft.

According to another embodiment of the invention, the universal joint includes driving and driven U-shaped connectors interconnected by mutually-interconnected pins extending from a first leg of each U-shaped connector to a second leg of each U-shaped connector.

According to another embodiment of the invention, the crankshaft includes an attachment element carried by the crankshaft for receiving an elongate driving element for rotating the crankshaft.

According to another embodiment of the invention, a crank for extending and retracting a shade, blind or the like of the type mounted on a horizontally-positioned roller is provided, and includes a crank housing, a crank stud mounted for rotation in the crank housing and having an end segment adapted to extend horizontally from the housing to be positioned in driving relation to a horizontal crank socket in an end of the roller, and a crankshaft positioned for rotation in the crank housing at a right angle to the crank stud. A driven gear coaxially-mounted on the crank stud and a driving gear coaxially-mounted on the crankshaft and interconnecting the crank stud and crankshaft is provided for transmitting rotation of the crankshaft to the crank stud. A driving U-shaped connector and a driven U-shaped connector are carried on the crankshaft and connected by mutually-interconnected pins extending from a first leg of each U-shaped connector to a second leg of each U-shaped connector for permitting the crankshaft to be rotated by non-axially aligned rotation of the crankshaft.

According to another embodiment of the invention, the driven gear includes a helical gear coaxially-mounted on the crank stud and the driving gear includes a worm gear coaxially-mounted on the crankshaft.

According to another embodiment of the invention, the crankshaft includes an attachment element carried by the crankshaft for receiving a driving element for rotating the crankshaft.

According to another embodiment of the invention, an attachment element is provided for receiving an elongate driving element for rotating the crankshaft.

According to another embodiment of the invention, a connector is provided, having an opening carried by the crankshaft for receiving a complementary connector of an elongate driving element for rotating the crankshaft.

According to another embodiment of the invention, the universal joint has a range of articulation of at least 45 degrees from an axis of rotation of the crankshaft.

According to another embodiment of the invention, the driving element is an elongate pole with a hook on one end for being extending through the opening in the attachment element for rotating the crankshaft.

According to another embodiment of the invention, a shade assembly is provided that includes a roller adapted for receiving a predetermined length of sheet material wrapped onto the roller to serve as a shade when extended from the roller, and a crank socket coaxially positioned on one end of the roller. A crank is provided for extending and retracting the blind, and includes a crank housing, a crank stud mounted for rotation in the crank housing and having an end segment adapted to extend from the housing and adapted for being positioned in driving relation to crank socket, and a crankshaft positioned for rotation in the crank housing at a right angle to the crank stud. A right-angle gear assembly is positioned in the crank housing and interconnects the crank stud and crankshaft for transmitting rotation of the crankshaft to the crank stud. A universal joint is positioned on an end of the crankshaft for permitting the crankshaft to be rotated by non-axially aligned rotation of the crankshaft.

According to another embodiment of the invention, the crankshaft includes an attachment element carried by the crankshaft for receiving an elongate driving element for rotating the crankshaft.

According to another embodiment of the invention, an attachment element carried by the crankshaft is provided, and has an opening for receiving an elongate driving element for rotating the crankshaft.

According to another embodiment of the invention, the driving element is an elongate pole with a hook on one end for being extending through the opening in the attachment element for rotating the crankshaft.

### BRIEF DESCRIPTION OF THE DRAWING FIGURES

The present invention is best understood when the following detailed description of the invention is read with reference to the accompanying drawings, in which:

FIG. 1 is an overall view of a typical roller shade illustrating a crank according to an embodiment of the invention;

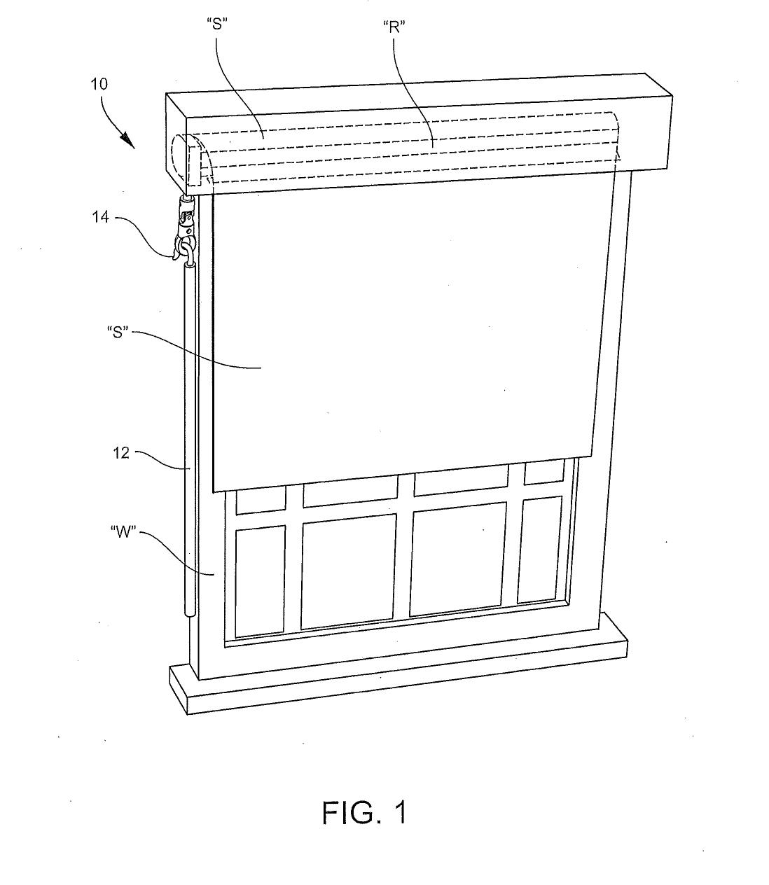

FIG. 2 is a perspective view of a crank according to one preferred embodiment; and

FIG. 3 is an exploded view of the crank shown in FIG. 2.

### DETAILED DESCRIPTION OF THE PREFERRED EMBODIMENT

Referring now to the drawings, a window “W” of typical construction is shown, above which is mounted a shade “S” on a roller “R”. A crank 10 according to a preferred embodiment of the invention is mounted on one side of the roller “R” and interconnects with the roller “R”, as described below, to permit the shade “S” to be extended from and retracted back onto the roller “R” as desired. Rotation of the crank 10 occurs by an operator, either manually or by motor, rotating a driving element, such as a pole 12 having a hook 14 on one end.

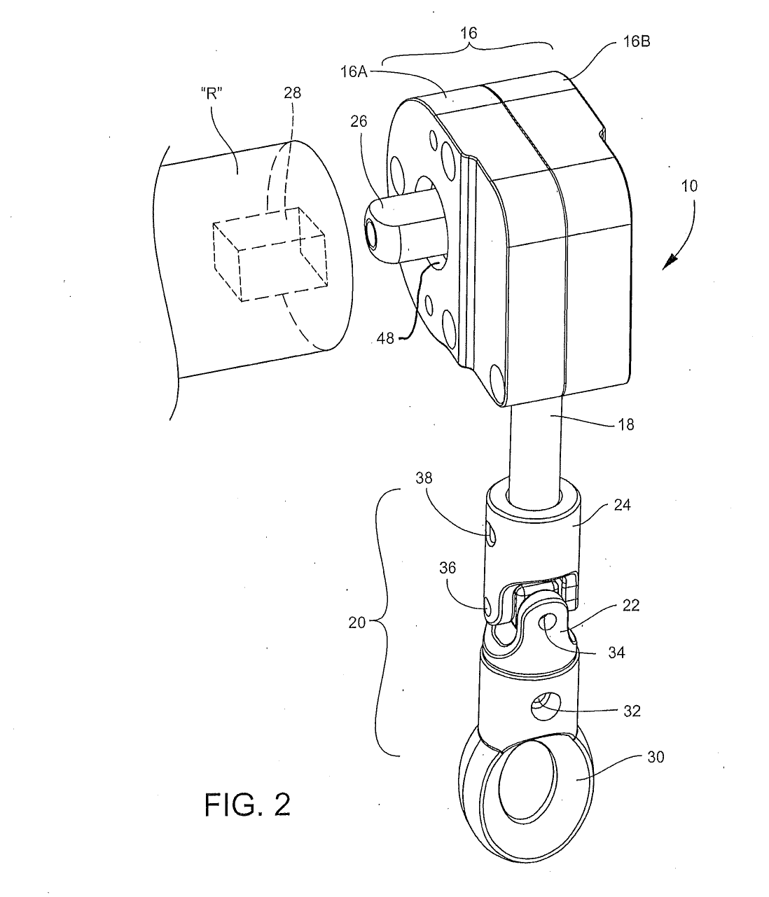

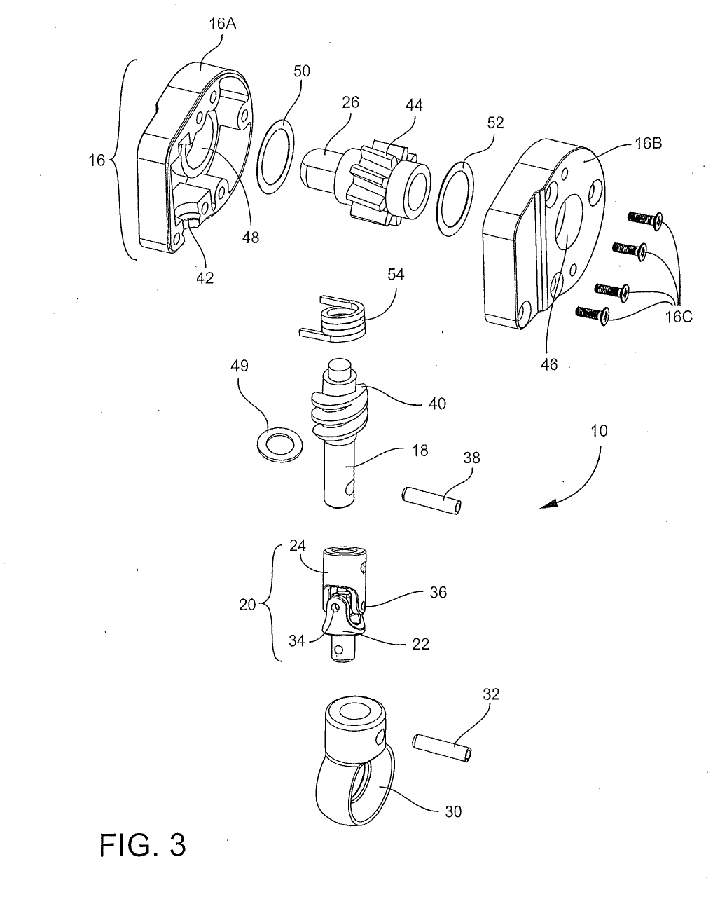

As shown in FIGS. 2 and 3, crank 10 includes a crank housing 16 formed of two housing shells 16A, 16B that are joined together by machine screws 16C as shown to form an interior in which operating elements are contained. The crank includes a crankshaft 18 and a universal joint 20, which formed of a pair of U-shaped driving and driven connectors 22, 24, respectively. The universal joint 20 rotates the crankshaft 18 which transmits rotation to a stud 26. The stud 26 is positioned in a socket 28 in the end of the roller “R” and as it rotates, transmits rotational movement to the roller “R”.

An attachment element, such as a ring 30, is attached to the driving connector 22 of the universal joint 20 by a pin 32. The driving and driven connectors 22 and 24 are interconnected by mutually interconnected pins 34 and 36. Both the driving and driven connectors 32, 34, are therefore permitted to pivot around the pins 36, 34, respectively, thus providing a range of articulation in the usual manner that can vary as the universal joint rotates. The crankshaft 18 is connected to the driven connector 24 by a pin 38, and a worm gear 40 is preferably integrally-formed on an upper end of the crankshaft 18. The crankshaft 18 is positioned in a crankshaft aperture 42 in the bottom of the housing 16, and the worm gear 40 extends upwardly into the housing 16 and meshes with a helical gear 44 mounted horizontally in two opposed gear mounting apertures 46, 48 the housing 16. A gasket 49 is positioned on the worm gear 40.

Helical gear is held in rotational position by a pair of gaskets 50, 52. Stud 26 is preferably integrally formed on one end of the helical gear 44 and extends through the gear mounting aperture 48 and is positioned in the socket 28, as shown in FIG. 2. A retaining spring 54 is positioned on the worm gear 40 above the gasket 49, as shown in FIG. 3 and engages the interior of the housing 16 to maintain the concentricity of the worm gear 40 in engagement with the helical gear 44. The crank 10 is mounted on the end of the roller “R” and is therefore able to extend or retract the shade “S” even though the operator is positioned at various positions within a distance defined by length and angle of orientation of the pole 12.

Any suitable driving mechanism can be used, including hand cranks and reversing motors, which can be mounted to drive the crank 10 from a location that is not coaxial with the crankshaft 18. The universal joint 20 preferably has a range of articulation of at least 45 degrees from an axis of rotation of the crankshaft 18.

A crank for extending and retracting a shade according to the invention has been described with reference to specific embodiments and examples. Various details of the invention may be changed without departing from the scope of the invention. Furthermore, the foregoing description of the preferred embodiments of the invention and best mode for practicing the invention are provided for the purpose of illustration only and not for the purpose of limitation, the invention being defined by the claims.

What is claimed is:

1. A crank for extending and retracting a shade, blind or the like of the type mounted on a horizontally-positioned roller, comprising:
(a) a crank housing;
(b) a crank stud mounted for rotation in the crank housing and having an end segment adapted to extend horizontally from the housing to be positioned in driving relation to a horizontal crank socket in an end of the roller:
(c) a crankshaft positioned for rotation in the crank housing at a right angle to the crank stud:
(d) a right-angle gear assembly positioned in the crank housing and interconnecting the crank stud and crankshaft for transmitting rotation of the crankshaft to the crank stud; and
(e) a universal joint positioned on an end of the crankshaft for permitting the crankshaft to be rotated by non-axially aligned rotation of the crankshaft.

2. A crank according to claim 1, wherein the right-angle gear assembly comprises a driven gear coaxially-mounted on the crank stud and a driving gear coaxially-mounted on the crankshaft.

3. A crank according to claim 1, wherein the right-angle gear assembly comprises a driven helical gear coaxially-mounted on the crank stud and a driving worm gear coaxially-mounted on the crankshaft.

4. A crank according to claim 1, wherein the universal joint comprises driving and driven U-shaped connectors interconnected by mutually-interconnected pins extending from a first leg of each U-shaped connector to a second leg of each U-shaped connector.

5. A crank according to claim 1, wherein the crankshaft includes an attachment element carried by the crankshaft for receiving an elongate driving element for rotating the crankshaft.

6. A crank for extending and retracting a shade, blind or the like of the type mounted on a horizontally-positioned roller, comprising:
(a) a crank housing;
(b) a crank stud mounted for rotation in the crank housing and having an end segment adapted to extend horizontally from the housing to be positioned in driving relation to a horizontal crank socket in an end of the roller:
(c) a crankshaft positioned for rotation in the crank housing at a right angle to the crank stud:
(d) a driven gear coaxially-mounted on the crank stud and a driving gear coaxially-mounted on the crankshaft and interconnecting the crank stud and crankshaft for transmitting rotation of the crankshaft to the crank stud; and
(e) a driving U-shaped connector and a driven U-shaped connector carried on the crankshaft and interconnected by mutually-interconnected pins extending from a first leg of each U-shaped connector to a second leg of each U-shaped connector for permitting the crankshaft to be rotated by non-axially aligned rotation of the crankshaft.

7. A crank according to claim 6, wherein the driven gear comprises a helical gear coaxially-mounted on the crank stud and the driving gear comprises a worm gear coaxially-mounted on the crankshaft.

8. A crank according to claim 6, wherein the crankshaft includes an attachment element carried by the crankshaft for receiving a driving element for rotating the crankshaft.

9. A crank according to claim 6, and including an attachment element for receiving an elongate driving element for rotating the crankshaft.

10. A crank according to claim 6, and including a connector having an opening carried by the crankshaft for receiving a complementary connector of an elongate driving element for rotating the crankshaft.

11. A crank according to claim 6, wherein the universal joint has a range of articulation of at least 45 degrees from an axis of rotation of the crankshaft.

12. A crank according to claim 11, wherein the driving element is an elongate pole with a hook on one end for being extending through the opening in the attachment element for rotating the crankshaft.

13. A shade assembly, comprising:
(a) a roller adapted for receiving a predetermined length of sheet material wrapped onto the roller to serve as a shade when extended from the roller;
(b) a crank socket coaxially positioned on one end of the roller;
(c) a crank for extending and retracting the blind, comprising:
(i) a crank housing;
(ii) a crank stud mounted for rotation in the crank housing and having an end segment adapted to extend from the housing and adapted for being positioned in driving relation to crank socket:
(iii) a crankshaft positioned for rotation in the crank housing at a right angle to the crank stud:
(iv) a right-angle gear assembly positioned in the crank housing and interconnecting the crank stud and crankshaft for transmitting rotation of the crankshaft to the crank stud; and
(v) a universal joint positioned on an end of the crankshaft for permitting the crankshaft to be rotated by non-axially aligned rotation of the crankshaft.

14. A crank according to claim 13, wherein the right-angle gear assembly comprises a driven gear coaxially-mounted on the crank stud and a driving gear coaxially-mounted on the crankshaft.

15. A crank according to claim 13, wherein the right-angle gear assembly comprises a driven helical gear coaxially-mounted on the crank stud and a driving worm gear coaxially-mounted on the crankshaft.

16. A crank according to claim 13, wherein the universal joint comprises driving and driven U-shaped connectors connected by mutually-interconnected pins extending from a first leg of each U-shaped connector to a second leg of each U-shaped connector.

17. A crank according to claim 13, wherein the crankshaft includes an attachment element carried by the crankshaft for receiving an elongate driving element for rotating the crankshaft.

18. A crank according to claim 13, and including an attachment element carried by the crankshaft and having an opening for receiving an elongate driving element for rotating the crankshaft.

19. A crank according to claim 18, wherein the driving element is an elongate pole with a hook on one end for being extending through the opening in the attachment element for rotating the crankshaft.
